(19) United States
(12) Patent Application Publication
(10) Pub. No.: US 2005/0240589 A1
(43) Pub. Date: Oct. 27, 2005

(54) Method and system to authorize user access to a computer application utilizing an electronic ticket

(76) Inventors: Michael Altenhofen, Karlsruhe (DE); Andreas S. Krebs, Karlsruhe (DE); Marcus Philipp, Ladenburg (DE); Christian Hochwarth, Wiesloch (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/875,257

(22) Filed: Jun. 23, 2004

Related U.S. Application Data
(60) Provisional application No. 60/564,712, filed on Apr. 22, 2004.

(51) Int. Cl. G06F 17/30

(52) U.S. Cl. 707/9

(57) ABSTRACT

A method and a system to authorize access to a network-based application generate electronic access information responsive to a first request. The first request is received at a first application from a requester for access to a second application. The electronic access information is communicated to the requestor. A second access request is received, at the second application from the requestor, for access to the second application, the second access request including the electronic access information. At the second application, the electronic access information is utilized to authorize access by the requester to the second application.

This application claims the priority benefit of co-pending U.S. provisional application Ser. No. 60/564,712 entitled “A METHOD AND SYSTEM TO AUTHORIZE PROVISION OF A COMPUTER-BASED TRAINING COURSE TO A USER UTILIZING AN ELECTRONIC TICKET” filed Apr. 22, 2004.

### FIELD OF THE INVENTION

An embodiment relates generally to the field of access authorization and, in one example, to a method and system to authorize provision of computer-based training to a user.

### BACKGROUND OF THE INVENTION

In today's networked environment, it is becoming increasingly easy and popular to provide access to server-based computing applications. For example, via the Internet, a user may execute a client application (e.g., a browser) on a remote machine, and via the client application have access to a wide variety of server-based applications. During a particular network-session, it is not uncommon for a user to transition from one server-based application to another. For example, consider the situation where a “portal” application acts as a front-end application to consolidate and aggregate access to more specialized applications (e.g., Personal Information Management (PIM) applications, financial applications, project management applications, Enterprise Resource Planning (ERP) applications etc.). As a user transitions from usage of one server-based application to another during a particular network session, a number of technical access authorization challenges and problems may be presented. Specifically, when a user, during a particular network session, interacts with a number of server-based applications over a network, a sophisticated user may be able to obtain unauthorized access to a particular server-based application.

One environment in which a user may be required to interact, during a network session, with multiple server-based applications is in the emerging field of computer-based learning or education (i.e., e-learning). In such environments, different learning modules, or different components of a curriculum or course, may be presented by different server-based applications. Further, access to such applications is often provided via an “e-learning” portal application, which provides a front-end interface to a number of more specialized server-based applications.

As organizations move to become more efficient in today's competitive environments, the training of personnel of organizations is becoming increasingly important. The globalization of work and education, short innovation cycles, large amounts of information, and increased business competition have made more urgent the necessity for efficient training of personnel.

The need for training has also been increased by the widespread adoption of automated information technology systems within organizations. The utilization of computer and information systems, however, has placed an increased burden on organizations to train personnel in the utilization of such systems. While traditional training courses and seminars are of course somewhat effective, the conducting of such training courses is often limited to an employee-intake process, or are otherwise scheduled at times that are not particularly convenient for personnel. Training received too far in advance of use of a particular information tool, may prove to be ineffective, while the scheduling of training courses at other times may interfere with work schedules. Accordingly, there has been a growth in the demand for so-called “just-in-time” learning and training.

One method to provide such “just-in-time” learning and training is through the deployment of computer-based training within an organization. Computer-based training courses may be web-based, or alternatively may be provided as stand-alone applications to which the personnel have access. Computer-based training courses allow personnel to receive training at a time that is most beneficial (e.g., when the need arises to use a particular information tool or to perform a particular task), and at a time that is convenient.

In prior art e-learning systems, which deliver computer-based training courses to users as web-based courses, the communication of information between a client system and a server system may be vulnerable to forgery and other security concerns. For example, information that is passed between a client system and a server system can often be forged by unauthorized users, who can then view e-learning content for another user. The ability of one user to access e-learning material of another user poses a number of serious problems, including allowing a fraudster to complete a course on behalf of a user and potentially allowing the user to be fraudulently certified as having a specific qualification or having received a specific training.

FIG. 1 is a prior art interface 2 to a learning portal application, whereby a user can initiate e-learning by starting a computer-based course. Specifically, the prior art interface 2 includes hypertext 4 that is user-selectable to initiate a web-based training course. A Uniform Resource Locator (URL) 6, associated with the hypertext 4, is displayed within the interface 2. The URL 6 encodes a plethora of information, but can easily be read and forged to allow a breach of training integrity and security. For example, the URL 6 may be obtained by an unauthorized user (e.g., with or without the consent of an authorized user). Once the unauthorized user has access to the URL 6, the unauthorized user may utilize this URL 6 to present him or herself to server-based e-learning application as another user.

It will also be appreciated that, as web-based e-learning environments become more complex, more information may need to be communicated between a client system and a server system. The inclusion of a large amount of information within a URL, such as the URL 6, can result in a URL becoming excessively long (e.g., exceeding 2 kilobytes). Such excessively long URLs are difficult to both construct and to read. Specifically, various URL encoding and decoding systems are required at both the client system and the server system to secure communications (i.e., encode and decode information included within URLs) between the client and server systems, and the complexity of these systems increases as the complexity of URLs increases.

In summary, it will be appreciated that security concerns associated with authorizing access to network-based applications, such as those that provide web-based training, present a number of technical security issues and challenges.

### SUMMARY OF THE INVENTION

According to one aspect, there is provided a method and a system to authorize access to an application. Electronic access information is generated responsive to a first request, received at a first application from a requester, for access to a second application. The electronic access information is communicated to the requestor. A second access request is received, at the second application and from the requester, for access to the second application, the second access request including the electronic access information. At the second application, the electronic access information is utilized to authorize access by the requester to the second application.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a screenshot showing a prior art method of providing a computer-based training course to a user.

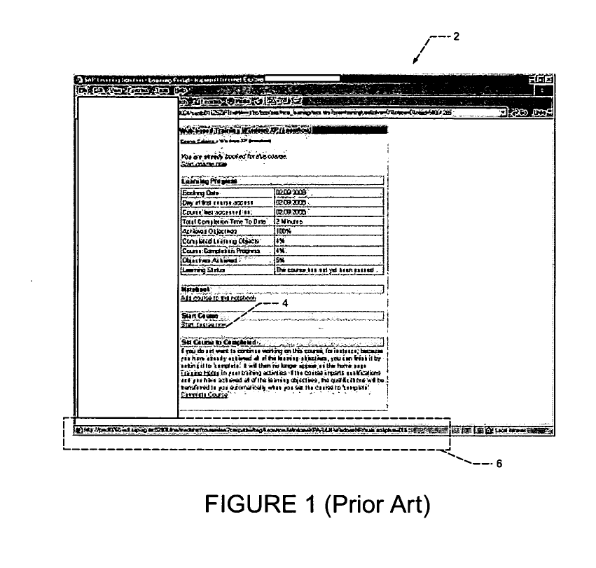

FIG. 2 is a block diagram illustrating a network environment within which an exemplary embodiment of the present invention may be deployed.

FIG. 3 is a flowchart illustrating a method, according to an exemplary embodiment of the present invention, to authorize provision of a computer-based training course (e.g., a web-based training material) to a user.

FIG. 4 is an interaction diagram providing further details regarding an exemplary method to authorize provision of a computer-based training course (e.g., a web-based training material) to a user.

FIG. 5 is a screen shot illustrating an exemplary portal interface, which may be generated by the learning portal application, according to an exemplary embodiment of the present invention.

FIG. 6 is a screen shot illustrating an exemplary content player interface that may be invoked on the client system, responsive to communication of a URL to the content player application.

FIG. 7 shows a diagrammatic representation of machine in the exemplary form of a computer system within which a set of instructions, for causing the machine to perform any one or more of the methodologies discussed herein, may be executed.

### DETAILED DESCRIPTION

A method and system to authorize user access to a computer-based application are described. In the following description, for the purposes of explanation, numerous specific details are set forth in order to provide a thorough understanding of the present invention. It will be evident, however, to one skilled in the art that the present invention may be practiced without these specific details.

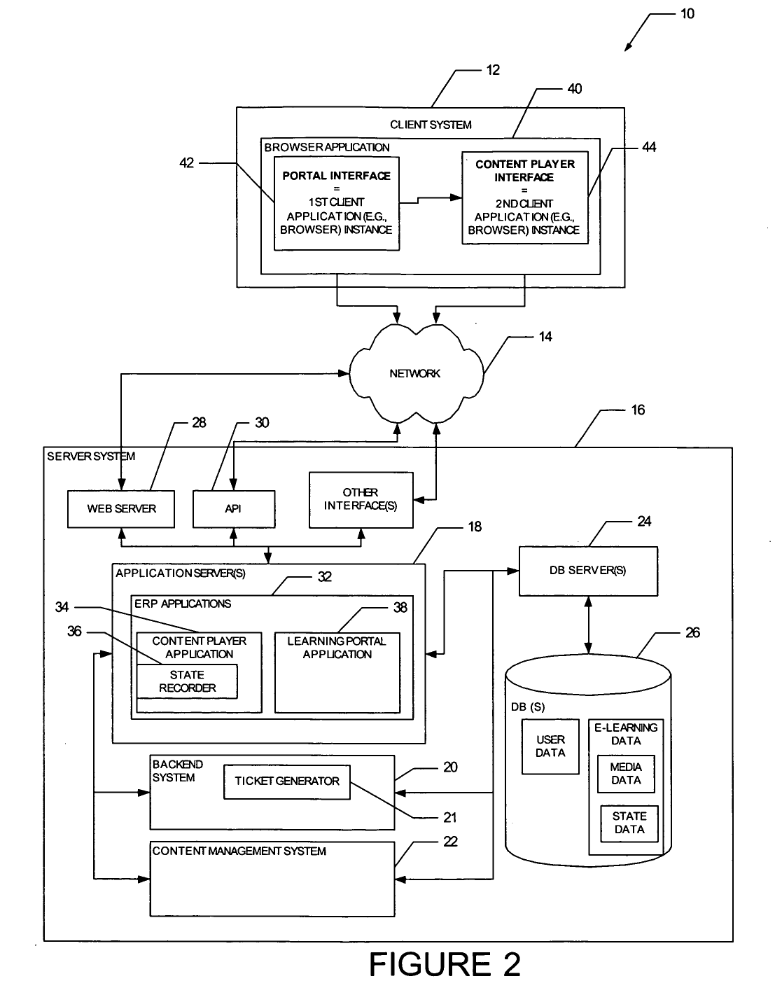

FIG. 2 is a block diagram illustrating a network environment 10 in which an exemplary embodiment of the present invention is deployed. While the network environment 10 is shown to deploy a client-server architecture, other network architectures (e.g., a peer-to-peer architecture) could also accommodate an embodiment of the present invention. The network environment 10 is shown to include one or more client systems 12 (e.g., a personal computer (PC), Personal Digital Assistant (PDA), cellular (or mobile) telephone etc.) which is coupled via a network 14 (e.g., the Internet or an intranet) to a server system 16, so as to facilitate communications (e.g., utilizing any one of a number of well-known communication protocols, such as http) between the client systems 12 and the server system 16.

The server system 16 includes a number of application servers 18, a backend system 20, and a content management system 22. The application servers 18, the backend system 20, and the content management system 22 are shown to be coupled to one or more database servers 24, which provide read/write access to one or more databases 26. In the exemplary embodiment, the databases 26 are shown to store user data, and e-learning data, the e-learning data including media data (e.g., graphic, video, and audio data that is included within the e-leaming material). The data within the databases 26 may be stored in tables (e.g., relational tables), as XML data structures or as objects (e.g., in an object-oriented database), to mention but a few examples.

The application servers 32 may be coupled to, and in communication with, a number of interface components, such as a web server 28 and Application Program Interface (API) 30 that attend to the appropriate formatting of communications issued from the server system 16 to the client system 12, and communications received at the server system 16 from client systems 12.

FIG. 2 illustrates the application servers 18 as hosting a number of applications. In the exemplary embodiment, these applications include Enterprise Resource Planning (ERP) applications 32. However, in alternative embodiments, the application servers 18 may host any number of applications (e.g., first, second, third applications, etc) between which a user may transition. Further, while FIG. 2 shows a single server system 16, embodiments of the present invention may find application in systems in which a user transitions between multiple applications, hosted on multiple application servers 18 that in turn form part of separate and distinct server systems 16. The various applications that are described below as being hosted by the application servers are, it will be appreciated, merely examples of applications, and embodiments of the present invention are not limited to ERP applications, or to “e-learning” applications. Nonetheless, for illustrative purposes, an embodiment of the present invention is discussed within the context of “e-learning” applications.

As noted above, the application servers 18 are, in the exemplary embodiment, shown to host a number of applications, including Enterprise Resource Planning (ERP) applications 32. The ERP applications 32 include, inter alia, a content player application 34 that is responsible for the delivery (e.g., upload or streaming delivery) of electronic material and media associated with an e-learning course to the client system 12. The content player application 34 further includes a state recorder 36, which maintains a record of electronic material and content communicated from the server system 16 to the client system 12, and also data and communications received at the server system 16 from the client system 12. Accordingly, the state recorder 36 maintains an indication of a trainee user's progress through electronic material that is included within a computer-based training course, and operates to “bookmark” a trainee user's location within course material.

The content player application 34 also recognizes a learning strategy associated with a particular trainee user, guides a trainee user through a computer-based training course, and determines learning progress, which may then be reflected in the state data associated with a user account (e.g., a trainee account).

The ERP applications 32 may also include a learning portal application 38, which provides an interface to a trainee (or learner) user and, depending on organization-specific adaptations, displays an overview of available course offerings, and also provides details regarding organizational training and education (e.g., in-person classroom training, virtual classroom training, web-based training, and other computer-based training). Such information regarding course offerings may include a course catalogue, course proposals, a training history, a qualifications catalogue, and qualifications files that are presented in a personalized form. Further, the learning portal application 38 may support online registration by a trainee user.

The backend system 20 is responsible for various backend functions to support the ERP applications 32, and is shown to include a ticket generator 21 that, in the exemplary embodiment of the present invention, operates to generate electronic access information in the exemplary form of electronic tickets that are communicated to the client system 12 for the purposes of authorizing access to a computer-based training course.

The content management system 22 stores and manages training content, and can be accessed either by a training user who plans and develops a course catalogue, an author user who registers actual course content, or a trainee user to which course content is provided.

Turning now to the client system 12, a browser application 40 (e.g., MS EXPLORER, developed by Microsoft Corporation of Redmond, Wash. State), is hosted, and supports a learning portal interface 42 and a content player interface 44. Specifically, the learning portal interface 42 is an interface, provided by the browser application 40, to the learning portal application 38, and the content player interface 44 is an interface to the content player application 34.

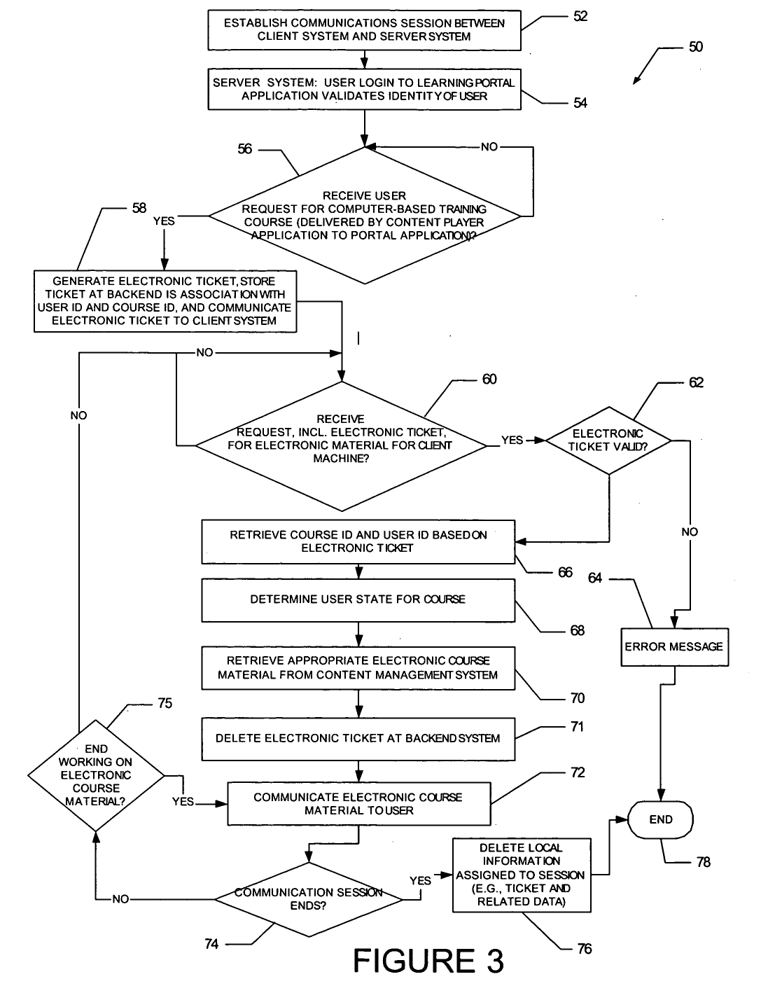

FIG. 3 is a flowchart illustrating a method 50, according to an exemplary embodiment of the present invention, to authorize access to a network-based application (e.g., a web-based training application) by a user. The method 50 commences at block 52 with the establishment of a communications session (e.g., an HTTP session) between a client system 12 and the server system 16.

At block 54, a user of the client system 12 logs into a first application (e.g., the learning portal application 38), this login process serving to validate the identity of the user. The login process may, for example, involve the user supplying a user name and password pair, via the learning portal interface 42, which is then communicated to, and validated by, the learning portal application 38.

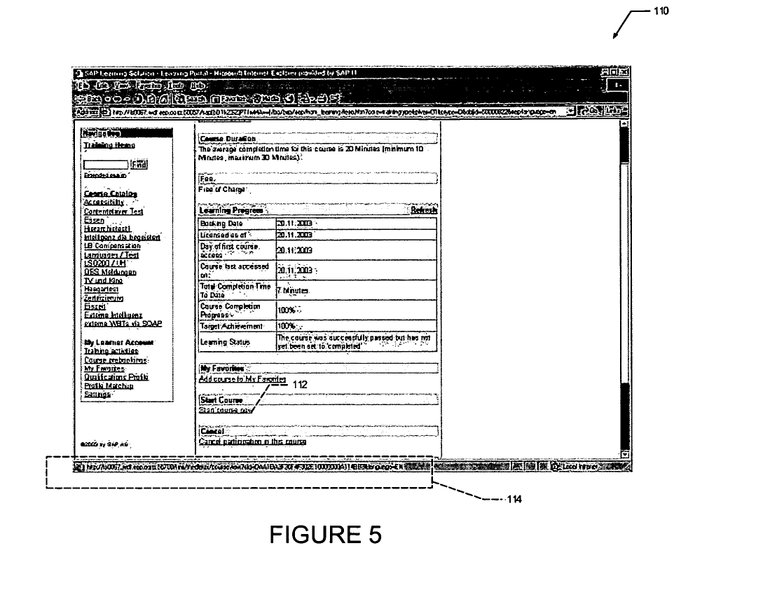

At decision block 56, the learning portal application 38 determines whether it has received a request from the user to access a second application (e.g., to commence a computer-based training course). For example, referring to an exemplary portal interface 110 illustrated in FIG. 5, user selection of the hypertext 112 may cause a request to initiate a computer-based training course to be communicated to, and received at, the learning portal application 38.

In the event that such a user request is received, at block 58, electronic access information, in the exemplary form of an electronic ticket, is generated at the server system 16, and stored within the backend system 20 in association with a user identifier and a course identifier, identifying the course that the relevant user has requested to be initiated. In one embodiment, the ticket generator 21 within the backend system 20 generates a random, or quasi-random, number that serves as the electronic ticket. The electronic ticket is then communicated from the server system 16 to the client system 12, for example in a URL.

Moving on to decision block 60, a determination is made as to whether a request, including the electronic ticket, has been received at the server system 16 from the client system 12 for electronic material associated with a computer-based training course. This request may, for example, take the form of a URL that is received from the content player interface 44. If such a request is received, at decision block 62 a determination is made whether the electronic ticket is valid or not. Specifically, the content player application 34 may receive the electronic ticket, and communicate the electronic ticket to the backend system 20 for verification. The backend system 20 proceeds to assess whether the received electronic ticket corresponds to any previously generated and stored electronic tickets. In the event that the electronic ticket is found to be invalid, an error message may be generated and communicated from the server system 16 to the client system 12 at block 64.

On the other hand, should the backend system 20 determine that the electronic ticket is indeed valid, the user and course identifiers associated with the electronic ticket are retrieved at block 66, and communicated from the backend system 20 to the content player application 34.

At block 68, the content player application 34 determines a user state for the course identified by the user identifier. As mentioned above, the content player application 34 includes a state recorder 36, which “bookmarks” a user's location within one or more computer-based training courses.

At block 70, having identified a course that the user wishes to participate in, and also having identified a location within that course to which a trainee user has advanced, the content player application 34 retrieves appropriate electronic course material from the content management system 22. At block 72, the retrieved electronic course material is then communicated by the content player application 34 to the client system 12 for presentation within the content player interface 44.

At block 71, the electronic ticket is deleted from the backend system 20, once it has been retrieved and utilized to perform the operation at blocks 66, 68 and 70. Specifically, in one embodiment, the backend system 20, having retrieved and communicated the course identifier and user identifier information based on the electronic ticket, then deletes the electronic ticket.

At decision block 74, the content player application 34 makes a determination as to whether the communications session, established at block 52, has terminated. For example, the user may terminate the content player interface 44, thereby terminating the communication session between client system 12 and the server system 16. The content player 34 then, at decision block 75, determines whether the user has finished working on the provided electronic course material. If not, the method 50 then loops back to decision box 60. Alternatively, if the user has finished working on the electronic course material, the method 50 may loop to block 72 where further electronic course material is communicated to the user.

On the other hand, should it be determined at decision block 74 that the communication (e.g., a HTTP) session has in fact ended, the content player application 34, at block 76, proceeds to destroy (or delete) local information assigned to the relevant session, including the ticket and related data.

The exemplary embodiment of the present invention, as discussed above, accordingly generates electronic access information (e.g., the electronic ticket) that is session-specific. The ticket is generated following the establishment of a validated and authenticated communication session (e.g., an HTTP communication session) between a client system 12 and the server system 16. Further, it will be noted that the electronic ticket is deleted from the backend system 20 after a retrieval and “attached” to a communications session between the browser application 40 and the content player application 34.

In various embodiments, the electronic ticket may be otherwise flagged or indicated as being associated with a particular communication session, and only valid for that particular communications session. The session-specific electronic tickets are accordingly only valid for a specific communications session and thus cannot be reutilized. Session-specific electronic tickets are thus difficult to forge, and it is difficult for an unauthorized user to obtain access to unauthorized e-learning materials.

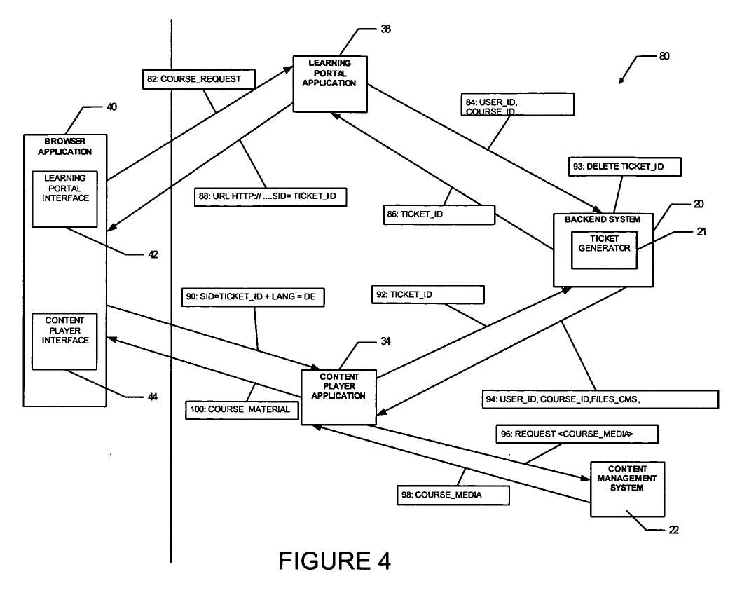

FIG. 4 is an interaction diagram providing further details regarding a method 80, according to an exemplary embodiment of the present invention, whereby electronic access information may be utilized to authorize provision of, for example, a computer-based training course within the context of the architecture of the server system 16. FIG. 4 illustrates that the browser application 40, via the learning portal interface 42, communicates a course request to the learning portal application 38, at block 82. Responsive to the course request, the learning portal application 38, at block 84, communicates a user identifier and a course identifier to the backend system 20. It will be appreciated that the learning portal application 38 is aware of the appropriate user identifier as a result of a user of the client system 12 having performed the authenticated login process discussed above. The learning portal application 38 is furthermore aware of the course identifier, as this would have been determinable from the course request communicated at block 82.

Having received the user identifier and the course identifier at block 84, the ticket generator 21 of the backend system 20 generates electronic access information in the form of an electronic ticket, which is then communicated from the backend system 20 to the learning portal application 38 at block 86. The learning portal application 38 then embeds the electronic ticket within a URL that is communicated to the browser application 40 at block 88. In one embodiment of the present invention, the electronic ticket may be utilized as a session identifier (SID) that is embedded within the URL communicated to the browser application 40 at block 88.

Responsive to receipt of the URL at block 88, the browser application 40 then generates a further browser instantiation in the form of the content player interface 44. The content player interface 44 then provides an HTTP request, based on information received in the URL to the content player application 34 at block 90. Specifically, the HTTP request communicated at block 90 includes the electronic ticket, as well as further user preference information (e.g., a language preference specifier).

At block 92, the content player application 34 extracts the electronic ticket from the communication received at block 90, and provides the electronic ticket to the backend system 20. The backend system 20 then validates the electronic ticket, as described above, and retrieves the user identifier, the course identifier and other information potentially associated with the electronic ticket. The retrieved user identifier and course identifier are then communicated at block 94 from the backend system 20 to the content player application 34.

FIG. 4 also shows that, at block 93, the backend system 20 proceeds to delete the electronic ticket responsive to the “retrieval” thereof.

The content player application 34, at block 96, issues a request to the content management system 22 for content (e.g., electronic media) associated with the identified course. The requested electronic course material is identified based on the course identifier received at block 94, as well as state information maintained by the content player application 34 indicating a location to which the user has progressed within the relevant course. Of course, it may be that the user has not previously commenced the identified course, in which case the state information indicates as such.

The content management system 22 then returns the requested electronic course material to the content player application 34 at block 98, whereafter the content player application 34 communicates electronic course material to the browser application 40 at block 100. The content player application 34 may supplement and customize the presentation of the course material, based on user preferences (e.g., the language preference communicated at block 90).

FIG. 5 is a screen shot illustrating an exemplary learning portal interface 110, which may be generated by the learning portal application 38, according to an exemplary embodiment of the present convention. The learning portal interface 110 is shown to provide information pertaining to an e-learning environment, and is specifically shown to include hypertext 112 that is user selectable to initiate a computer-based training course. The URL illustrated at 114 is associated with the hypertext 112, and includes electronic access information, in the exemplary form of the electronic ticket, that may be generated as discussed above and communicated to the learning portal application 38 for inclusion within a URL to be communicated to the content player application 34. It will be noted that URL 114 includes a session identifier (SID), this SID comprising an example of electronic access information that may be utilized by the server system 16 to validate the provision of a computer-based training course to a user. The URL 114 is also shown to include preference information, in the exemplary form of a language preference.

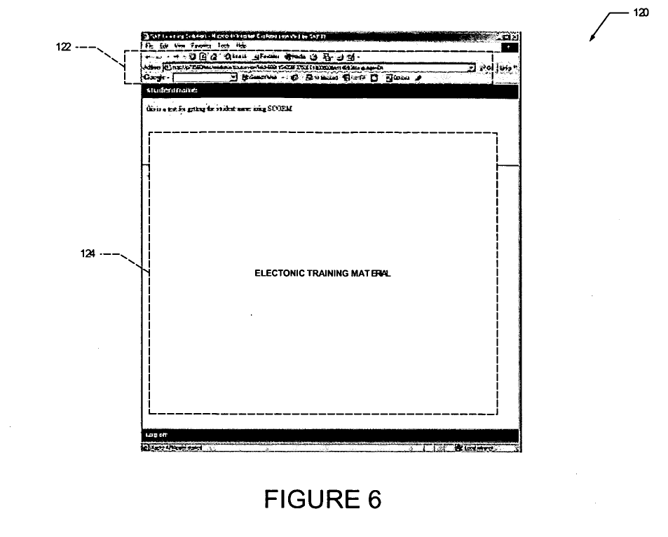

FIG. 6 is a screen shot illustrating an exemplary content player interface 120 that may be invoked on the client system 12, responsive to communication of the URL 114 to the content player application 34. It will be noted that the URL 122, indicated in the URL address line of the content player interface 120, corresponds to the URL 114 associated with the hypertext 112 of the learning portal interface 110 shown in FIG. 5. The content player interface 120 then serves to present electronic training material 124 to a user.

The URL 114, which is communicated from the client system 12 to the server system 16, allows the server system 16 to retrieve any information regarding the user of which the server system 16 is aware as a result of the user login operation that was performed via the portal interface 42 to the learning portal application 38. Accordingly, the need to incorporate voluminous information within the URLs communicated from the client system 12 to the server system 16 is reduced. Furthermore, as the electronic ticket embedded within the URL 114 is session-item specific, the ease of which security can be breached is reduced.

For the purposes of this specification, the term “computer-based training course” should be taken to include training materials and content (e.g., course and tests) that may be distributed via a network (e.g., the Internet or an intranet, such as so-called web-based training courses), as well as training materials and content that may be distributed for offline training (e.g., via a CD-ROM, or that may execute on a mainframe). The term “computer-based training course” shall also be taken to include so-called “virtual classrooms”.

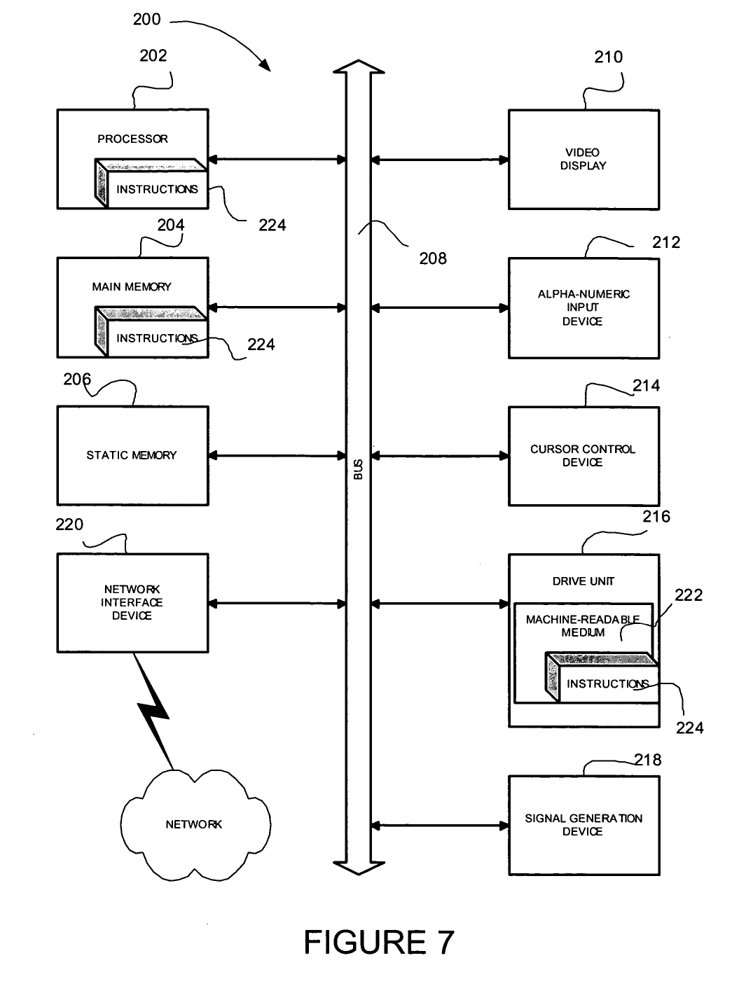

FIG. 7 shows a diagrammatic representation of machine in the exemplary form of a computer system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 200 includes a processor 202 (e.g., a central processing unit (CPU), a graphics processing unit (GPU) or both), a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220 utilizing any one of a number of well-known transfer protocols (e.g., HTTP).

While the machine-readable medium 292 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Thus, a method and system to authorize access to a network-based application by a user have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to authorize access to an application, the method including:
responsive to a first request, received at a first application from a requestor and for access to a second application, generating electronic access information;
communicating the electronic access information to the requester;
receiving a second access request, at the second application and from the requester, for access to the second application, the second access request including the electronic access information; and
at the second application, utilizing the electronic access information to authorize access by the requestor to the second application.

2. The method of claim 1, including deleting the electronic access information responsive to the utilization thereof to authorize access by the requestor to the second application.

3. The method of claim 1, wherein the electronic access information is generated and operatively stored at a backend system to which both the first and second applications have access.

4. The method of claim 1, wherein the first request includes an identification of electronic content, available via the second application, the first application to communicate an electronic content identifier for the electronic content to the backend system, and the backend system to store the electronic content identifier in association with the electronic access information.

5. The method of claim 4, wherein the utilization of the electronic access information to authorize the access of the requestor to the second application includes communicating the electronic access information to the backend system.

6. The method of claim 5, including communicating the electronic content identifier from the backend system to the second application responsive to the communication of the electronic access information from the second application to the backend system.

7. A system to authorize access to an application, the system including:
a first application, responsive to a first request received via a network from a requestor for access to a second application, to generate electronic access information and to communicate the electronic access information to the requestor via the network; and
a second application to receive a second access request, via the network and from the requester, for access to the second application, the second access request including the electronic access information, the second application to authorize access by the requestor utilizing the electronic access information.

8. The system of claim 7, including a backend system to generate and operatively store the electronic access information.

9. The system of claim 8, wherein the backend system is to delete the electronic access information responsive to the utilization thereof by the second application to authorize access by the requestor to the second application.

10. The system of claim 7, wherein the first request includes an identification of electronic content, available via the second application, and the first application is to communicate an electronic content identifier for the electronic content to the backend system, and the backend system to store the electronic content identifier in association with the electronic access information.

11. The system of claim 10, wherein the second application is to utilize the electronic access information to authorize the access of the requestor to the second application by communicating the electronic access information to the backend system.

12. The system of claim 11, wherein the backend system is to communicate the electronic content identifier to the second application responsive to the communication of the electronic access information from the second application to the backend system.

13. A machine-readable medium storing a sequence of instructions that, when executed by a machine, cause the machine to perform a method to authorize access to an application, the method including:
responsive to a first request, received at a first application from a requester and for access to a second application, generating electronic access information;
communicating the electronic access information to the requestor;
receiving a second access request, at the second application and from the requester, for access to the second application, the second access request including the electronic access information; and
at the second application, utilizing the electronic access information to authorize access by the requestor to the second application.

14. A system to authorize access to an application, the system including:
first means, responsive to a first request received via a network from a requestor for access to a second application, for generating electronic access information and for communicating the electronic access information to the requester via the network; and
second means for receiving a second access request, via the network and from the requester, for access to the second application, the second access request including the electronic access information, the second application for authorizing access by the requestor utilizing the electronic access information.

15. A method to authorize provision of a computer-based training course to a user, the method including:
establishing a communications session between a client system and a server system, the server system hosting a computer-based training course application;
at the server system, validating an identity of the user;
at the server system, responsive to a request received from the client system to initiate the computer-based training course, generating electronic access information and storing the electronic access information at the server system, the request to initiate the computer-based training course including a course identifier identifying the computer-based training course;
at the server system, responsive to the request to initiate the computer-based training course, communicating the electronic access information to the client system;
at the server system, receiving a request for electronic material, associated with the computer-based training course, from the client system, the request for the electronic material including the electronic access information;
at the server system, responsive to receipt of the request for the electronic material, retrieving a user identifier and the course identifier associated with the electronic access information; and
at the server system, communicating the electronic material, as identified utilizing the course identifier, to the user.

16. The method of claim 15, wherein the validating of the user identity includes receiving and validating login information for the user.

17. The method of claim 15, wherein the generating of the electronic access information includes randomly generating an access code.

18. The method of claim 15, wherein the client system hosts a browser application to display the electronic material, associated with the computer-best training course, to the user, and wherein the electronic access information is communicated from the server system to the client system within a Uniform Resource Locator (URL).

19. The method of claim 18, wherein the receipt of the request for the electronic material at the server system is received from the browser application hosted on the client system.

20. The method of claim 19, wherein the request for the electronic material is received from a second instance of the browser application.

21. A computer-based training system comprising:
a learning portal application server to support establishing a communication session with a client system of a user, to validate an identity of the user, and, responsive to a request from the user to initiate a computer-based training course, to cause generation of electronic access information that is associated with a user identifier of the user and a course identifier of the computer-based training course, the learning portal application server further to communicate the electronic access information to the client system; and
a content player to receive a request for electronic material associated with the computer-based training course from the client system, to retrieve the user identifier and the course identifier utilizing the electronic access information, to retrieve the electronic material utilizing the course identifier, and to communicate the electronic material to be client system.
